(19) United States
(12) Patent Application Publication
(10) Pub. No.: US 2005/0004423 A1
(43) Pub. Date: Jan. 6, 2005

(54) Collapsible, protective containment device

(75) Inventors: Joseph T. Shenosky, Rockville, MD (US); Mark F. Kaye, Falls Church, VA (US)

Correspondence Address: STAAS & HALSEY LLP, SUITE 700, 1201 NEW YORK AVENUE, N.W., WASHINGTON, DC, 20005, US

(73) Assignee: Alion Science and Technology, McLean, VA (US)

(21) Appl. No.: 10/841,428

(22) Filed: May 10, 2004

Related U.S. Application Data
(60) Provisional application No. 60/479,853, filed on Jun. 20, 2003.

(51) Int. Cl. A61G 10/00

(52) U.S. Cl. 600/21

(57) ABSTRACT

A collapsible, protective containment device isolates a patient in a controlled environment. The containment device has a flexible containment wall, a closure device an air ventilation device and a plurality of ribs. The flexible containment wall is expandable from a collapsed state to define an interior region for receiving at least a portion of a patient therein and providing an impermeable barrier about the portion of the patient, for at least a selected contaminant. The closure device closes the containment wall about the patient to provide a substantially airtight interior region. The air ventilation device provides a gas comprising oxygen to the substantially airtight interior. The plurality of inflatable ribs provided along a length of the containment wall, the inflatable ribs defining one or more air compartments separate from the interior region within the containment wall, the one or more inflatable ribs supporting the containment wall away from the patient.

### CROSS REFERENCE TO RELATED APPLICATIONS

This application is based on and hereby claims priority to U.S. Provisional Application Ser. No. 60/479,853 filed on Jun. 20, 2003, the contents of which are hereby incorporated by reference.

### BACKGROUND OF THE INVENTION

The threat to health from biological and chemical contaminants has, if anything, increased over the last several years. The popular press is full of accounts of potential biological attacks which might either be privately or state sponsored. Chemical terrorist attacks have already occurred in various areas of the world and certain governments have engaged in chemical attacks against enemies and even members of their own society. While the risks from chemical attacks are believed to be substantial, in the future the threat of biological attack may continue to increase and may become more significant than chemical attacks.

Unlike conventional weapons, exposure by rescuers to victims of chemical or biological attack can adversely affect these rescuers. To avoid such affects on rescuers, including medical and transport personnel, it is necessary to isolate the victims of the attack. Additionally, it may be necessary to transport non-contaminated patients through zones that are already contaminated or are under the threat of chemical or biological attack. Meanwhile, in the civilian sector it is increasingly required to treat all emergency patients as potentially infectious and hazardous to personnel and equipment. This requires the use of isolation techniques during transport and treatment.

In addition to chemical attacks, highly infectious diseases, for which no cure has been found, require isolation. For example, severe acute respiratory syndrome (SARS) is easily transmitted, and has severe consequences. Containment is necessary to prevent this disease from spreading.

U.S. Pat. Nos. 6,241,653, 6,321,764, 6,418,932 and 6,461,290 describe various aspects of known containment devices. Each of U.S. Pat. Nos. 6,241,653, 6,321,764, 6,418,932 and 6,461,290 is hereby by incorporated by reference.

In the known containment devices, a containment wall may be supported away from a patient through hoop-like supports. Each support is attached to the containment wall, with a plurality of supports provided along the length of the containment wall. The supports pull the containment wall away from the patient. However, the containment device must be transported before use, and it is difficult to transport the device with the supports fixed to the containment wall. Also, it is difficult to secure the supports to the containment wall in the field. Additionally, the bottoms of the supports are biased away from one another. This could cause the supports to separate from the containment wall (if provided on the outside) or puncture the containment wall (if provided on the inside).

Known containment devices are also have problems associated with sealing together the open parts of the containment wall. Various proposals have been brought forward regarding closing a top of the containment wall to a bottom of the containment wall. However, it is still difficult to maintain a seal between the top and bottom of the containment wall, which seal will not unexpectedly open and will contain contaminants within the device.

One of the primary purposes of a containment device is to be able to treat the patient while avoiding infection. Although the patient is usually held within the containment device temporarily, there is a need for the ability to provide at least first aid services. Without the ability to interact with the patient, a containment device is somewhat useless. A simple plastic wrap could be used around the body of the patient and an oxygen mask could be placed around the face of the patient. Although access to the patient is a concern, the known devices have not provided sufficient flexibility. The known devices gave the healthcare worker insufficient latitude in deciding how to treat the patient. In addition, many of the known treatment methods could not be administered to an infectious patient without the healthcare worker risking infection.

### SUMMARY OF THE INVENTION

To possibly address the above concerns and/or different concerns, the inventor proposes a collapsible, protective containment device isolates a patient in a controlled environment. The containment device has a flexible containment wall, a closure device an air ventilation device and a plurality of ribs. The flexible containment wall is expandable from a collapsed state to define an interior region for receiving at least a portion of a patient therein and providing an impermeable barrier about the portion of the patient, for at least a selected contaminant. The closure device closes the containment wall about the patient to provide a substantially airtight interior region. The air ventilation device provides a gas comprising oxygen to the substantially airtight interior. The plurality of inflatable ribs provided along a length of the containment wall, the inflatable ribs defining one or more air compartments separate from the interior region within the containment wall, the one or more inflatable ribs supporting a pressure sufficient to support the containment wall away from the patient.

The closure device may include a first manipulatable zipper seal, first and second flaps and an adhesive flap. The first manipulatable zipper seal is formed from first and second strips provided respectively on the first and second ends of the containment wall. The first and second strips have reclosable interlocking profiles to seal the first and second ends of the containment wall to one another. The first and second flaps are provided on the containment wall and have a second manipulatable zipper seal formed from third and fourth strips provided respectively on the first and second flaps. The third and fourth strips having reclosable interlocking profiles to seal the first and second flaps to one another. The adhesive flap is provided on the containment wall such that the first flap is attached to the containment wall between the first end of the containment wall and the adhesive flap. The adhesive flap has an adhesive strip and a release layer to seal the adhesive flap to a sealing position on the containment wall after the release layer have been removed. The sealing position is located such that the second flap is attached to the containment wall between the second end of the containment wall and the sealing position.

To treat the patient, the containment device may have an adapter, a removable container, an injection unit, and a cap. The adapter is sealed to a flexible sleeve and has an inner circumference that defines an aperture. The removable container holds patient fluid. The removable container fits within the aperture in the adapter and has a sealed end that temporarily opens when pierced. The injection unit is fastened to the flexible sleeve and has first and second ends. The first end has a needle to pierce the patient's skin, and the second end is in fluid communication with the first end and has a tip to pierce the sealed end of the container. The cap connects to the adapter to hold the second end of the injection unit within the sealed end of the container.

For flexibility in treatment, the containment device may have an aperture in the containment wall and first through third aperture sealing units. The first aperture sealing unit seals the aperture from the at least one contaminant and provides a first access to the patient. The second aperture sealing unit seals the aperture temporarily while the first aperture sealing unit is still attached to the aperture. The third aperture sealing unit covers the aperture while the second aperture sealing unit is attached to the aperture. The third aperture sealing unit provides a second access to the patient.

To improve access, the containment device may have a sleeve extending form the containment wall to define an aperture in the containment wall. In this case, the sleeve has inner and outer circumferences. The outer circumference has inner and outer grooves exterior to the interior region. The inner groove accommodates a first aperture sealing unit which provides access to the patient. The outer groove accommodates a third aperture sealing unit which provides access to the patient. The inner groove is closer to the containment wall than the outer groove. The inner circumference of the sleeve receives a second aperture sealing unit while the first aperture sealing unit is being replaced by the third aperture sealing unit.

The containment device may have a call unit provided within the interior region. The call unit has an alert unit and an activation mechanism manipulatable by the patient to trigger the alert unit and request patient attention from outside of the interior region.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a front perspective view of an isolation device according to one aspect of the invention;

FIG. 2 is a top view of a containment wall shown in FIG. 1;

FIG. 3A is a back perspective view of the isolation device shown in FIG. 1;

FIG. 3B is a side view of a device which could be used to inflate ribs of the contaminant device;

FIGS. 4A and 4B are side views of a sealing mechanism to seal the top and bottom of the containment wall to one another, showing an unsealed and sealed relationship, respectively;

FIG. 5 is a prospective side view of the sealing mechanism, showing the containment device as sealed;

FIG. 6 is an outer prospective view of one side of the sealing mechanism in a partially sealed configuration;

FIG. 7 is a cross-sectional view showing one embodiment of an interlocking seal profile shown in FIGS. 4-6;

FIG. 8A is a side cross-sectional view of an alternate embodiment for the sealing mechanism;

FIG. 8B is a side view of a clipping fastener, which can be used to seal the sealing mechanism shown in FIG. 8A;

FIG. 9 is a perspective view of an adapter which fits within an access hole shown in FIG. 1, with a glove attached to the adapter;

FIGS. 10A and 10B are side and cross-sectional views, respectively, of the adapter shown in FIG. 9;

FIG. 11 is a top view of an O-ring;

FIG. 12 is a cross-sectional side view of a temporary seal device;

FIG. 13 is a side sectional view of a blood sampling adapter;

FIG. 14 is a top view of the adapter shown in FIG. 13;

FIG. 15 is a side view of an injection unit to be used with the blood sampling adapter shown in FIG. 13;

FIG. 16 is a cross-sectional view of a cap, which fits on the blood sampling adapter shown in FIGS. 13 and 14;

FIG. 17 is a side view of a sampling container, which connects to the injection unit shown in FIG. 15;

FIG. 18 is a side cross-sectional view of a help call signaling device and associated components.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

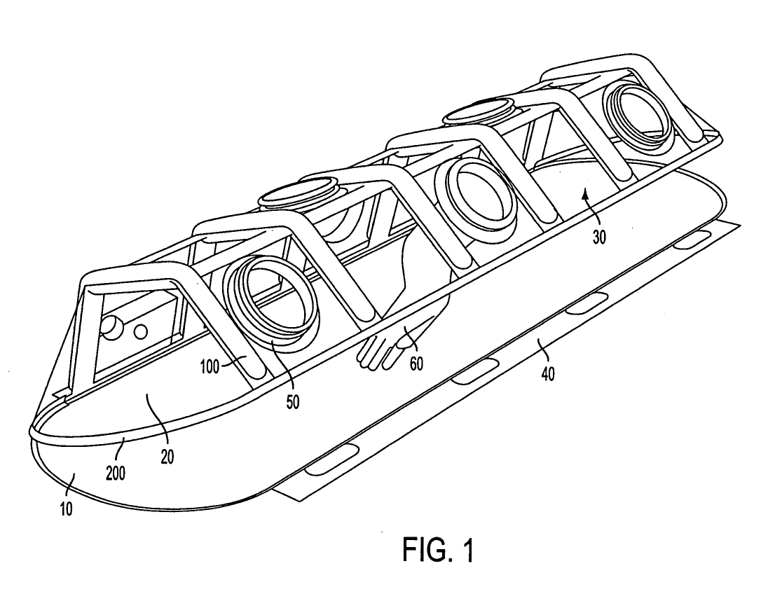

FIG. 1 is a front perspective view of an isolation device according to one aspect of the invention. In FIG. 1, the isolation device is shown as having a bottom 10 and a top 20. Although the bottom 10 and top 20 are shown as being formed of different pieces material, it is certainly possible that a single piece of material could function as both the top and bottom. The material may be polyvinyl chloride or other material suitable for maintaining a sealed relationship between a patient and a medical worker.

A patient would lie within an interior region 30. The patient would be placed within the interior region 30 if that the patient would otherwise have a potential to create a condition of harm to others, for example by spreading an infectious disease. Reference numeral 40 represents a stretcher, which could be used to transport the patient to a facility that has more permanent equipment for infection isolation.

The top 20 and bottom 10 together define a containment wall. The isolation device or “pod” is shown as being open. Accordingly, a lip 200 of the top 20 is not in contact with the bottom 10. When the containment device is occupied by a patient, the top 20 and bottom 10 would ordinarily be sealed to one another.

The containment device has access holes 50, which allow access to the patient. Glove 60 represents one way to access the patient. The glove 60 has an outer end which is sealed to the corresponding access hole 50 such that contaminants cannot escape to the environment through either the glove 60 or the corresponding access hole 50. A medical worker can reach his hand into the access hole 50, fit his hand into the glove 60 and provide assistance to the patient.

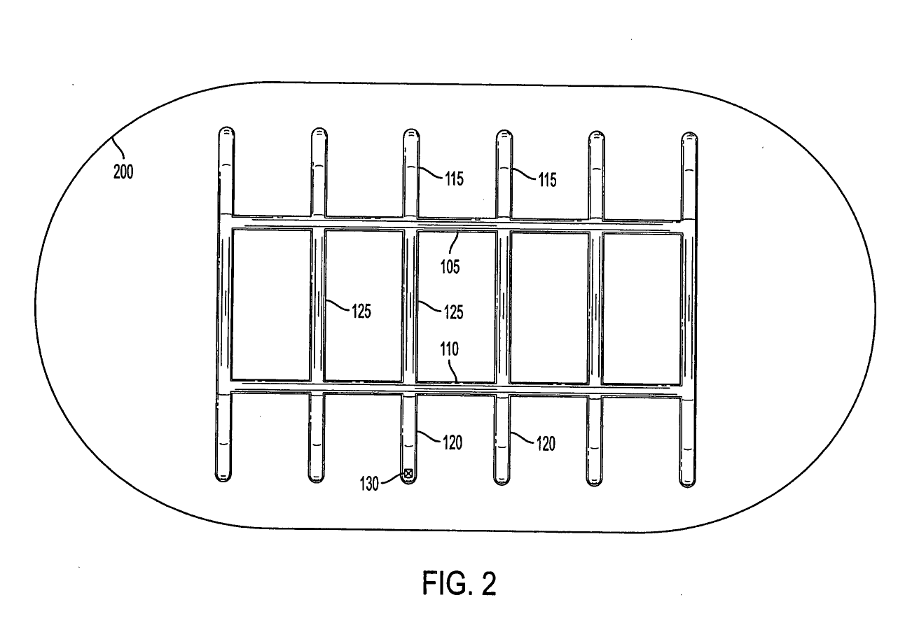

In one embodiment, the containment wall is formed from a flexible material. When the top 20 and bottom 10 are sealed to one another, pressure inside the containment device may be less than or greater than the pressure outside of the containment device. If the interior region 30 is at a positive relative pressure, then the pressure assists in maintaining the containment wall away from the patient. However, even if such a positive pressure condition exists, it is still necessary for the containment wall to be supported while loading the patient into the device. To support the flexible material of the containment wall away from the patient, inflatable support ribs 100 are provided. FIG. 2 is a top view of the containment device, showing the inflatable ribs 100 in particular. As can be seen, there are top ribs 105, 110, which extend substantially the length of the containment device. Rib 105 is shown toward the front of the device, and rib 110 is shown toward the back of the device. Extending down from the top rib 105 toward the front of the device, front lateral ribs 115 provide support. These are the ribs that are most visible in FIG. 1. Opposite the front lateral ribs 115, back lateral ribs 120 extend down the back of the containment device. Connecting ribs 125 extend across the containment device, between the top ribs 105 and 110.

As can be seen, all of the ribs are connected. When the containment device is collapsed for shipping prior to use, the ribs would be deflated. However, when preparing the containment device for use, the ribs would be inflated through an inflation unit 130. Although the exact positioning of the inflation unit 130 may be varied, it is shown on the back side of the containment device, towards the bottom of one of the back lateral ribs 120.

FIG. 2 shows the top 20 of the containment wall. Reference numeral 200 represents an edge or lip of the top 20.

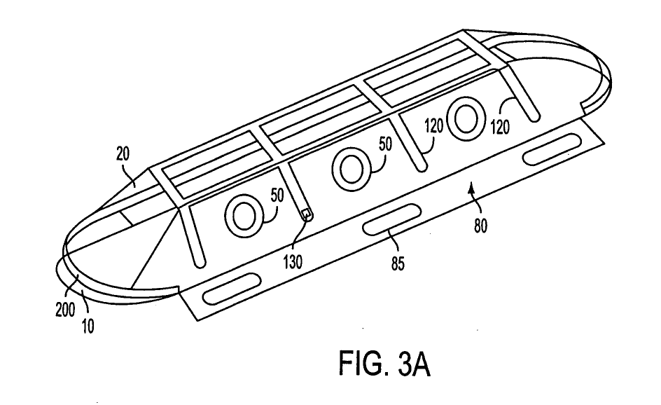

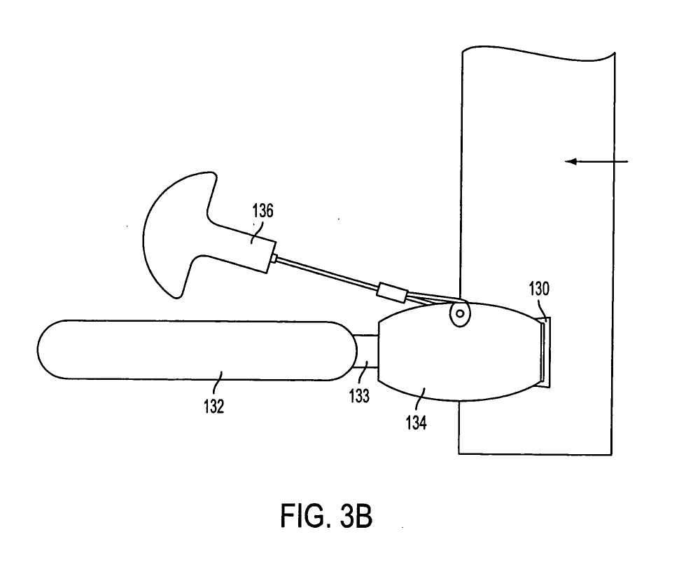

FIG. 3A is a back perspective view of the isolation device shown in FIG. 1. FIG. 3A shows the back lateral ribs 120 and the inflation unit 130. FIG. 3A also shows a dragging flap 80 attached to the containment wall. The dragging flap 80 has handles 85 which can be used to drag the containment device for short distances, for example, when a stretcher is not present.

When it is necessarily to inflate the ribs 100, the inflation unit 130 is activated, perhaps by connecting a pump to the inflation unit 130, by triggering a gas cartridge located within the ribs 100 or by puncturing an external gas cartridge, which is sealed to the inflation unit 130.

FIG. 3B is a side view of a device which could be used to inflate ribs of the contaminant device. In FIG. 3B, reference numeral 132 represents a carbon dioxide canister having a nozzle 133. A connector 134 receives the nozzle 133 and is inserted into the inflation unit 130. A pull trigger 136 is attached to the connector 134. When the pull trigger 136 is pulled, the CO₂ canister 132 is punctured, allowing the gas to permeate the ribs 100.

Regardless of the source, the gas travels from the inflation unit 130 toward the intersection of the corresponding back lateral rib 120 and the top back rib 110. From this intersection, the gas permeates throughout the ribs 100 to inflate each of the ribs.

One-way membranous valves may be provided to isolate ribs from one another. For example, if each rib is connected to the top back rib 110, a one-way membranous valve may be provided at the intersection of each rib and the top back rib 110. The top back rib 110 would be unobstructed so that air can freely flow through the top back rib 110. However, the one-way membranous valves only allow air to flow in a direction from the top back rib 110 to the lateral ribs. In this manner, if one of the lateral ribs 100 is punctured, air cannot flow into the punctured rib from the remainder of the ribs. Air can only flow out of the punctured rib. With the provision of one-way membranous valves, deflation of the ribs may be more difficult. However, the containment device may be designed as a one-time use device, which can be disposed of by hazardous waste disposal personnel.

In FIG. 2, the lateral ribs are connected to each other through both the top back rib 110 and the top front rib 105. Alternatively, the top front rib 105 could be eliminated. As a further alternative, one-way membranous valves could also be provided at the intersection of each lateral rib and the top front rib 105. It is also possible to use one way membranous valves to separate portions of the device instead of to separate individual ribs. For example, if the isolation device is supported by four sections of ribs, a central chamber could supply air to each section. To prevent the sections from interacting, one-way membranous valves could be positioned at the intersection of each section and the central chamber.

The above describes the ribs as being filled with a gas, such as air or carbon dioxide. If the patient has to be transported by aircraft, there could be significant pressure changes between when the patient is loaded into the containment device and when the patient is transported. In this case, it would be highly undesirable for the ribs to puncture or collapse under the changed pressure conditions. To prevent this, the ribs 100 may alternatively be filled with a polyurethane injection foam sealant similar to the building insulation foam sold under the name Great Stuff™ by Dow Chemical Corporation of Midland Mich. This foam spreads from the inflation unit 130 to the remainder of the ribs. After injection, the foam hardens.

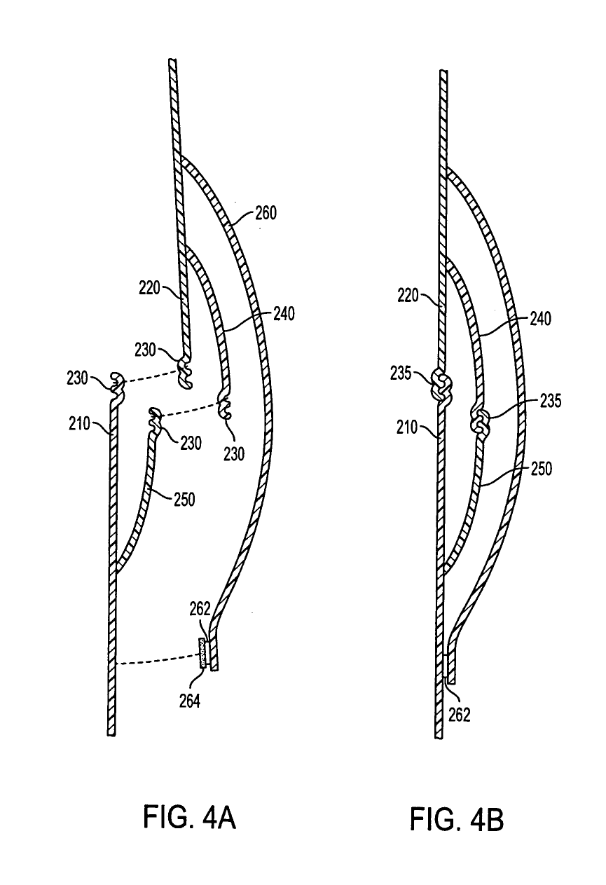

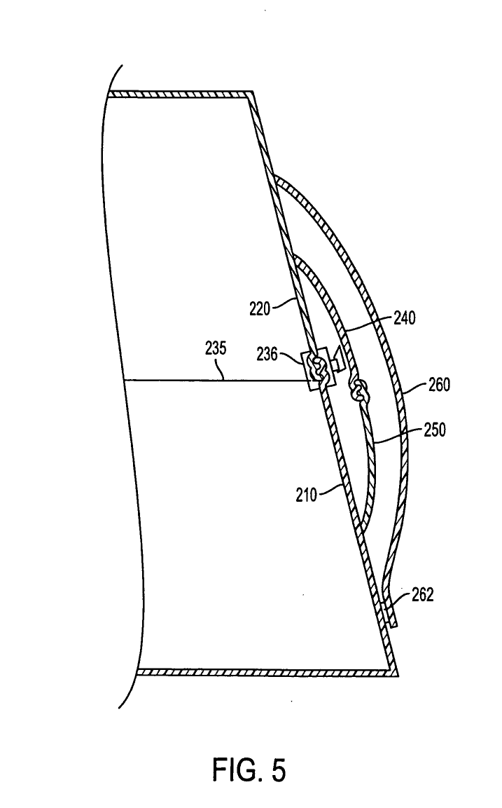

FIGS. 4A and 4B are side views of a sealing mechanism to seal the top and bottom of the containment wall to one another, showing an unsealed and sealed relationship, respectively. FIG. 5 is a prospective side view of the sealing device showing the containment device as sealed. FIG. 6 is an outer prospective view of one side of the sealing device, in a partially closed configuration.

In order to seal the top half 20 to the bottom half 10, there are two reclosable interlocking profile zipper seals and one adhesive seal. A first interlocking zipper seal is formed between a top lip 220 and a bottom lip 210. Both the top and bottom lips 220, 210 have interlocking seal profiles 230. The shape of the profiles are complimentary such that when the two profiles are pushed together, a seal 235, similar to that used for food storage bags, is created. In addition, a second zipper seal is formed between a top primary flap 240 and a bottom primary flap 250. As with the top and bottom lips 220, 210, the top and bottom primary flaps 240, 250 have interlocking seal profiles 230. The profiles are complimentary, such that a similar seal 235 can be formed between the top and bottom primary flaps 240, 250. As a further measure of safety, an adhesive flap 260 is provided. At the end of this flap, an adhesive member 262 is provided. The adhesive member is shown in FIG. 4A as being covered by a release sheet 264.

FIG. 6 shows both the seal between the top and bottom lips 220, 210 and the seal between the top and bottom flaps 240, 250. FIG. 6 also shows that these two seals are sealed in different directions. That is, the seal between the top and bottom lips 220, 210 is formed by moving a zipper 236 from left to right. The seal between the top and bottom primary flaps 240, 250 is formed by moving a zipper 236 from right to left. Thus, for the top and bottom lips 220, 210, there is a seal to the left of the zipper 236, and there are separated interlocking seal profiles 230 to the right of the zipper 236. For the seal between the top and bottom primary flaps 240, 250, there is a seal 235 to the right of the zipper 236, and there are separated interlocking seal profiles 230 to the left of the zippers 236. By having the zipper 236 moving in opposite directions, a better seal may be formed. That is, for the seal between the top and bottom lips 220, 210, the weakest part of the seal will be to the right of the zipper 236. For the seal between the top and bottom primary flaps 240, 250, the weakest part of the seal will be to the left of the zipper 236. These “weakest parts” are separated by substantial distance. Accordingly, if a contaminant escapes from the lower seal (between top and bottom lips 220, 210), the contaminant would need to travel a substantial distance before reaching the weakest part of the upper seal (between top and bottom primary flaps 240, 250.

In FIG. 6, the top and bottom lips 220, 210 can be seen through the top and bottom primary flaps 240, 250. This is because both the top and bottom primary flaps 240, 250 and the containment wall having the top and bottom lips 220,210, may be formed of a flexible transparent material. One possible benefit of transparency is that the patient can be observed through the material. On the other hand, it is of course possible that the containment wall and the top and bottom primary flaps 240, 250 may be formed of a translucent or opaque material.

In FIG. 5, the zipper 236 is shown for the seal between the top and bottom lips 220, 210. The zipper 236 for the seal 235 between the top and bottom primary flaps 240, 250 would be to the left of what is shown in FIG. 5. That is, the upper seal is formed by moving the zipper from right to left. In FIG. 5, the upper seal is shown as being formed. Therefore, the zipper 236 must have been moved to the left, past what is shown in FIG. 5.

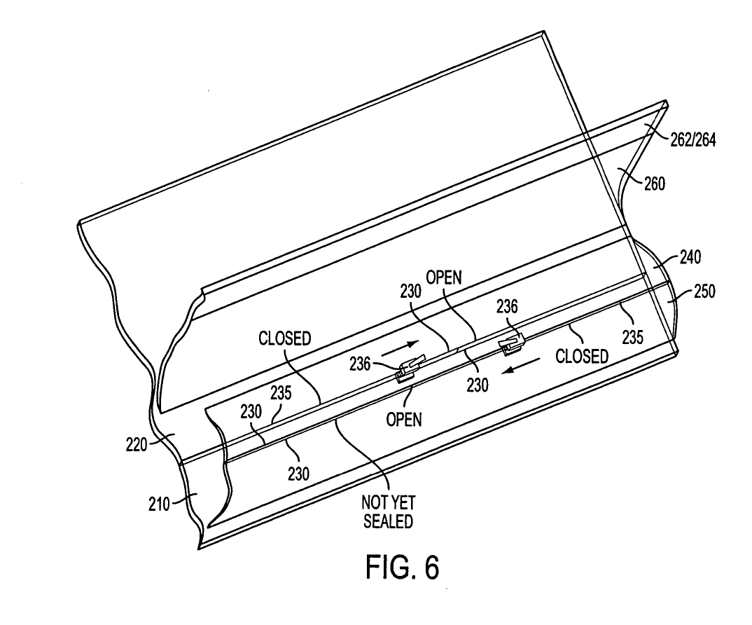

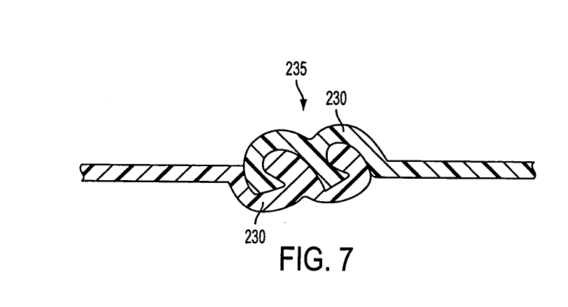

FIG. 7 is a cross-sectional view showing one embodiment of the interlocking seal profiles shown in FIGS. 4-6. Reference numeral 235 shows that when the interlocking seal profiles 230 are sealed to one another, the seal 235 is formed.

As to the sealing procedure, first, the top and bottom lips 220, 210 are sealed to one another. To do this, the top and bottom lips 220, 210 are brought into close contact with each other by pulling back the primary flaps 240, 250 and the adhesive flap 260 from their positions shown in FIGS. 4A and 4B. The reclosable seals are then closed by drawing the zipper 236 along the seam between the top and bottom lips 220, 210. As the zipper 236 is pulled forward, a seal is formed between lips 220, 210, behind the zipper 236. In order to open the seal, the zipper 236 is simply drawn in the opposite direction.

Once the seal between the top and bottom lips 220, 210 has been formed, then the top and bottom primary flaps 240, 250 are sealed to one another in a similar manner. Specifically, the top and bottom flaps are brought into contact with each other in the vicinity of the interlocking seal profiles 230 provided thereon. A zipper 236 is attached (if not already attached) between the top and bottom primary flaps 240, 250 in the vicinity of the respective interlocking seal profiles 230. The zipper 236 is drawn along the intersection of the two flaps to create a seal behind the slide.

After the top and bottom lips 220, 210 and the top and bottom primary flaps 240, 250 are both sealed, then the adhesive flap 260 is secured. In FIG. 5, adhesive flap 260 is shown as extending from the top 20. However, the adhesive flap 260 could also extend from the bottom 10. To secure the adhesive flap 260, the release sheet 264 is removed from the adhesive member 262. Then, the adhesive member 262 is pressed into place onto the opposite side. That is, if the adhesive flap 260 is provided on the top 20, then the adhesive member 262 is secured to the bottom 10.

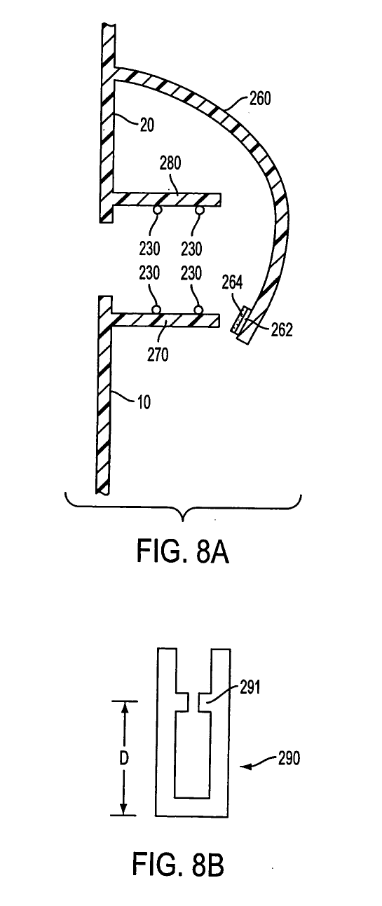

FIG. 8A is a side view of an alternate embodiment for the sealing mechanism. In FIG. 8A, the top and bottom lips 220, 210 are replaced by top and bottom extension members 280, 270. Each of the top and bottom extension members 280 and 270 has a pair of interlocking seal profiles 230. The opposing interlocking seal profiles 230 can be reclosably sealed together to form two interlocking seals. After this has been completed, the adhesive flap 260 is secured to the bottom 10 via the adhesive member 262.

In order to close the reclosable seals, manual pressure can be used. Alternatively, FIG. 8B is a side view of a clipping fastener 290, which can be used with the seals shown in FIG. 8A. The clipping fastener 290 has projections 291 which are placed on the top and bottom extension members 280, 270, opposite from the interlocking seal profiles 230. The projections 291 apply a sufficient amount of the pressure to the interlocking seal profiles 230 in order to close the seal. The clipping fastener 290 shown in FIG. 8B has a depth D, which corresponds to the distance of the respective interlocking seal profiles 230 from the distal end of the top or bottom extension members 280, 270. If the two seals are to be sealed independently, the depth D would correspond with the targeted seal. Alternatively, if the two seals are to be sealed simultaneously, two sets of opposing projections 291 would be provided on the clipping fastener 290.

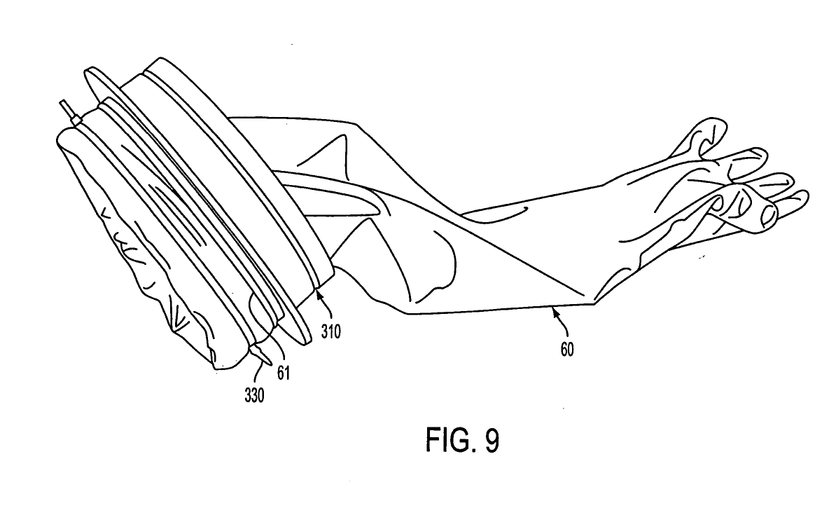

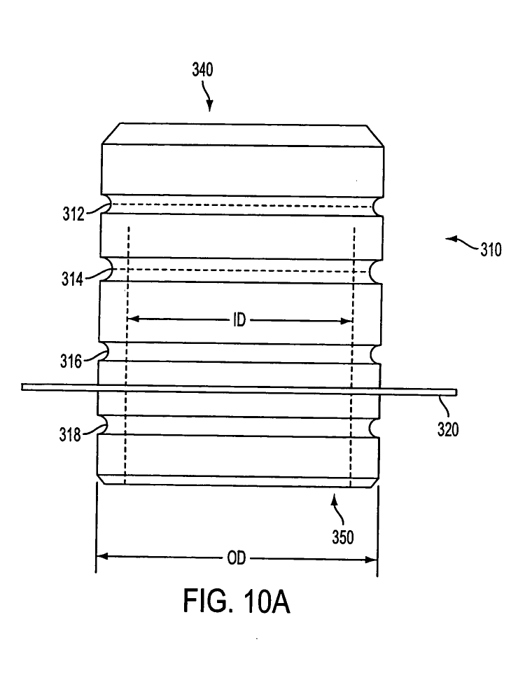

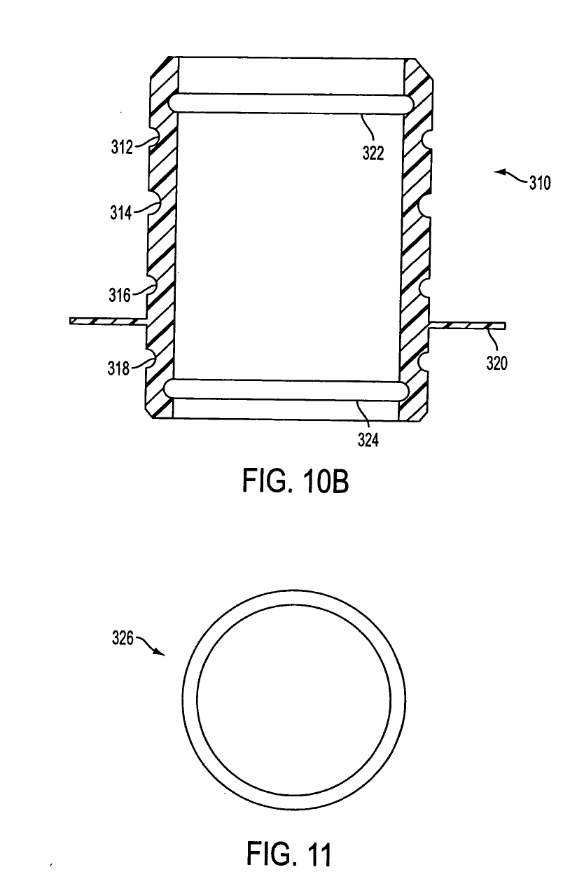

FIG. 9 is a perspective view of an adapter 310, with a glove 60 attached to the adapter 310. The adapter 310 fits within an access hole 50 shown in FIG. 1. FIGS. 10A and 10B are side and cross-sectional views respectively of the adapter 310. The adapter is shown in FIGS. 10A and 10B as having four grooves 312, 314, 316, 318. Not all of the four grooves 312-318 are necessary, as will be apparent from the functioning described below. The adapter 310 also has an extension ring 320. The adapter 310 may be formed from nylon, glass-filled nylon or a plurality of other conventional thermo-plastic materials. The adapter 310 may be formed by injection molding, for example. The adapter 310 is placed into a hole in the containment wall having approximately the same size as the outer diameter OD of the adapter 310. In this manner, the extension ring 320 overlaps the containment wall. The adapter 310 is secured to the containment wall via the extension ring 320. This can be done by heat welding (radio frequency or ultrasonic), which partially melts corresponding portions of the containment wall and the extension ring 320 until the two are permanently attached. The extension ring 320 can also be sealed to the containment wall through known adhesives.

The adapter 310 allows the glove 60 to be replaced with a new glove. This may be desired, for example, when there is damage to an original glove. The adapter 210 also allows the glove 60 to be replaced with various other care devices, such as a blood sampling device. All of this can be done without allowing contaminants to escape from the interior region of the containment device.

Replacement of a glove 60 will now be described. Referring to FIG. 9, the glove has an outer border 61, which ordinarily rests within the groove 316. A tie wrap 330 may be used to provide additional assurance that the glove 60 will not be accidentally removed from the adapter 310. The tie wrap 330 may rest with the groove 314.

Referring to FIG. 10B, the adapter 310 has first and second O-ring grooves 322, 324, formed on the inside of the adapter 310. FIG. 11 is a top view of an O-ring 326. The O-ring 326 can be fit into groove 322 or groove 324. With the O-ring 326 and the O-ring grooves 322, 324, the glove 60 is held against the inner circumference of the adapter 310. Positioning the O-ring 326 within groove 324 prevents contaminants from moving up between the glove 60 and the inner circumference of the adapter 310. Positioning an O-ring within groove 322 is somewhat optional, but groove 322 also helps with the seal.

To replace the glove 60 with a difference accessory, the tie wrap 330 is removed. If there is an O-ring within the first O-ring groove 322, this O-ring is removed. At this point, only the O-ring in the second O-ring groove 324 is sealing the glove. Then, the outer border 61 of the glove 60 is slid out of the groove 316 and moved to the top 340 of the adapter 310 until the outer border 61 retracts to a smaller diameter. The glove 60 is moved into the adapter 310 with the O-ring 326 still resting within the second O-ring groove 324. Then, a new accessory is fit over the adapter 310. Like the glove 60, the new accessory is a resilient, stretchable sleeve with an outer border 61. The outer border 61 of the new accessory is fit into groove 316. Then, a tie wrap and at least one O-ring are used to secure the new accessory. When inserting an O-ring 326 into the second O-ring groove 324 for the new accessory, the old O-ring, which held the glove 60, is pushed out of the second O-ring groove 324. At this point, the glove 60 is released from the adapter 310 so as to fall within the interior region 30 of the isolation device. The glove 60 can remain within the interior region without disturbing the patient. Since the containment device may be 100% disposable, it is possible for the glove 60 to never be removed from the interior region 30.

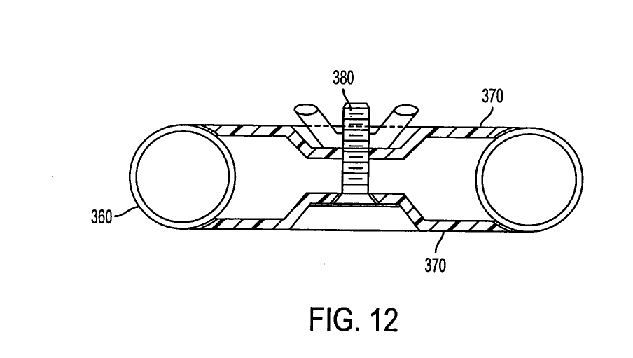

Ordinarily, a glove 60 provides a seal between the patient and the caregiver. However, if something should puncture the glove 60, the seal could be compromised. FIG. 12 is a cross-sectional side view of a temporary seal device. If the glove 60 is damaged, then the temporary seal device is inserted into the adapter 310 from the top opening 340. The temporary seal device has a ring shaped air bladder 360 having an outer diameter which is approximately the same size as the inner diameter ID of the adapter 310. A pair of compression plates 370 are provided interior to the ring shaped air bladder 360, on opposing sides of the air bladder 360. The air bladder 360 is bonded and sealed to the compression plates 370. A compression mechanism 380, shown as a threaded rod with a wing not, is used to control the spacing between the two compression plates 370. When the compression plates 370 are separated from one another, such that the air bladder 360 is at its full height, the outer diameter of the air bladder 360 is slightly smaller than the inner diameter ID of the adapter 310. This allows the temporary seal device to be inserted into the adapter 310. When the compression mechanism 380 is tightened and the compression plates 370 are moved toward one another, the height of the air bladder 360 decreases, causing the air bladder 360 to expand outwardly to tightly hold the glove 60 against the inside of the adapter 310.

Inserting the temporary seal device is the first step when a glove 60 or other accessory is damaged. After the temporary seal device is installed, the tie wrap 330 can be removed. With the temporary seal device in place, the risk of contamination is substantially eliminated. The outer border 61 of the glove 60 can be slid out of the groove 316 and over the top end 340 of the adapter 310. After the outer border 61 is moved over the top 340, a new accessory is fit over the glove 60. The outer border 61 of the new accessory is fit into groove 316.

At this point, the new accessory can be secured to the adapter 310 with a tie wrap. The compression mechanism 380 is manipulated through the resilient stretchable sleeve of the new accessory so as to release the temporary seal device from the inner circumference of the adapter 310. Then, both the damaged glove 60 and the temporary seal device are moved into the containment device. This displaces the O-ring of the old glove 60 which is still resting within the second O-ring groove 324. The temporary seal device and the damage glove 60 can be moved into the containment device from the top end 340 using manual manipulation and the flexible characteristics of the new accessory attached to the adapter 310. The damaged glove 60 and temporary seal device can also be pulled into the interior of the containment device from the bottom end 350 using a glove provided on an adjacent access hole.

A groove 318 is provided on the bottom side 350 of the adapter 310, below the extension ring 320. When the adapter 310 is connected to the containment device, the groove 318 is within the interior of the containment device. The groove 318 can accommodate an outer border 61 of a glove or an outer border of another accessory. However, because the groove 318 is located toward the bottom end 350, the glove or other device which is fastened to the groove 318 would ordinarily not be replaceable. That is, once a glove is removed from groove 318, it would be difficult to place another glove around groove 318.

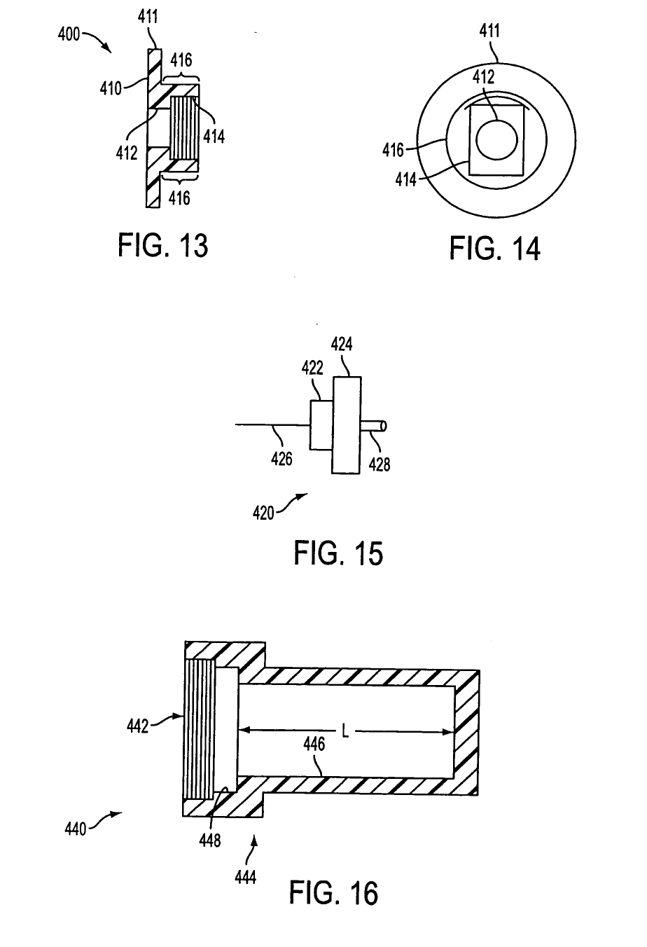

FIG. 13 is a side sectional view of a blood sampling adapter 400. The adapter 400 has an extension ring 410 which is sealed to a flexible material. Ordinarily, the flexible material would not be the containment wall. The flexible material would be analogous to the sleeve of the glove. That is, the flexible material would allow health caregiver to manipulate a blood sampling device (to be described below) within the blood sampling adapter 400. The extension ring 410 has an outer circumference 411.

FIG. 14 is a top view of the adapter 400 shown in FIG. 13. The adapter 400 has two inner circumferences 412 and 414. The inner circumference 412 has a circular cross section, whereas the inner circumference 414 has a rectangular cross section.

FIG. 15 is a side view of an injection unit to be used with the blood sampling adapter shown in FIG. 13. The injection unit 420 has first and second outer circumferences 422, 424 which match the inner circumferences 412, 414 of the blood sampling adapter 400. That is, the outer circumference 424 has a rectangular cross section, and the outer circumference 422 has a circular cross section. At one end of the injection unit 420, a needle 426 may be provided to pierce the patient's skin. At the other end, a piercing outlet device 428 may be provided to allow blood to travel from the needle 426 to a sampling container. An intervenous line connector may be used in place of the needle 426.

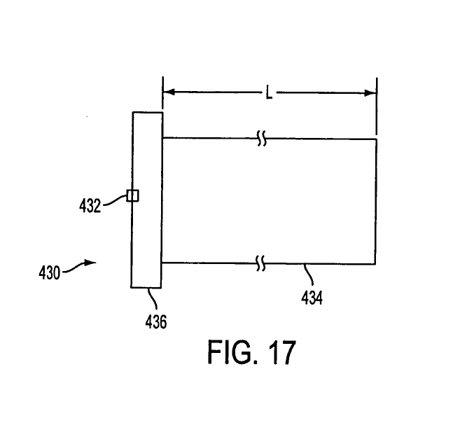

FIG. 17 shows a sampling container 430, which connects to the injection unit 420 shown in FIG. 15. The sampling container 430 has a reclosable seal 432 which is pierced by the piercing outlet device 428 when blood is being received. When the piercing outlet device 428 is removed from the reclosable seal 432, the seal 432 closes to shut the opening made for the piercing outlet device 428.

The injection unit 420 may have a valve mechanism such that blood can only flow out of the piercing outlet device 428 when in contact with the reclosable seal 432. Ordinarily, the injection unit 420 would be secured to the blood sampling adapter 400, perhaps with an adhesive or heat welding. With the valve mechanism, the injection unit 420 maintains a containment seal between the patient and the health caregiver. Because the containment device shown in FIG. 1 may be used for only a single patient, there is not a danger of disease being transmitted through reuse of the needle 426.

FIG. 16 is a cross-sectional view of a cap 440, which fits on the blood sampling adapter 400 shown in FIGS. 13 and 14. The cap 440 has threads 442 which interlock with threads 416 provided on the blood sampling adapter 400. In this manner, the cap 440 is screwed onto the blood sampling adapter 400. The cap 440 has inner circumferences 446, 448, which match outer circumferences 434, 436 provided on the sampling container 430. The cap 440 also has a length L, which matches a length L of the sampling container 430. The sampling container 430 is placed within the cap 440. When the cap 440 is screwed onto the blood sampling adapter 400, the piercing outlet device 428 pierces through the reclosable seal 432, and blood is drawn. Thereafter, the cap 440 is removed, and the bodily fluid within the sampling container 430 is ready for testing.

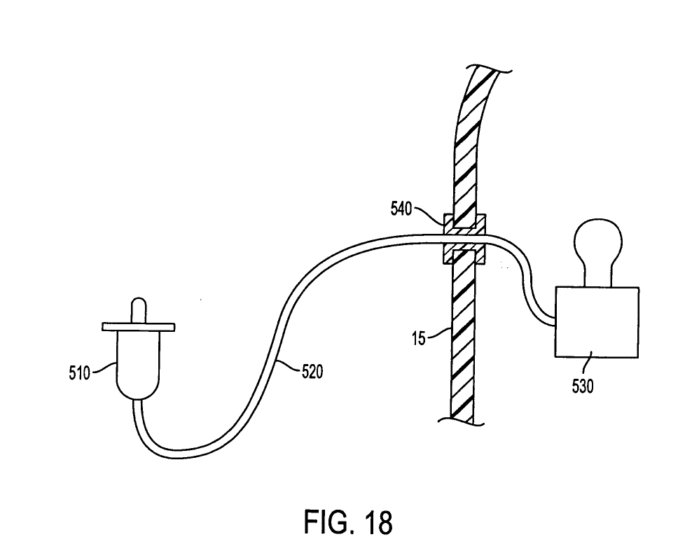

FIG. 18 is a side cross-sectional view of a help call signaling device and associated components. In FIG. 18, a hand held switch 510 can be held by the patient. When the patient needs help, the patient triggers the switch 510. The switch 510 sends a signal along a communication link 520. The communication link 520 may be a pneumatic or electrical communication link. Alternatively, the communication link 520 may be a wireless link. The signal travels through the communication link 520 to an alert device 530. In traveling, the signal passes through the containment wall, represented by reference numeral 15. The containment wall 15 may either be formed of the bottom 10 or top 20 of the device. To fasten the communication link 520 to the wall 15, without spreading contaminants, a sealed aperture 540 is provided. The aperture 540 is sealed to the containment wall 15 by adhesive, RF welding or other conventional techniques. The sealed aperture 540 is secured to the communication link 520 by a pressure seal and/or an adhesive seal.

The communication link 520 is connected to the alert device 530, as described previously. FIG. 18 schematically shows the alert device 530 embodied as a light bulb. However, various other alert devices may be used, such as a speaker and an amplifier system (if the switch 510 is replaced with a microphone). An alert sound device may be used in addition to or in the alternative to the light.

FIG. 18 shows the alert device 530 being provided exterior to the interior region of the containment device. On the other hand, the alert device 530 could be incorporated into the containment device as long as the signal for help could be transmitted through the containment wall 15. For example, if the containment wall 15 is transparent, and the alert device 530 were a simple light, then a light could be directly attached to the switch 510, within the interior region of the containment device.

The invention has been described in detail with particular reference to preferred embodiments thereof and examples, but it will be understood that variations and modifications can be effected within the spirit and scope of the invention.

1. A collapsible, protective containment device for isolating a patient in a controlled environment, comprising:
a flexible containment wall expandable from a collapsed state to define an interior region for receiving at least a portion of a patient therein and providing an impermeable barrier about the portion of the patient, for at least a selected contaminant;
a closure device for closing the containment wall about the patient to provide a substantially airtight interior region;
an air ventilation device to provide a gas comprising oxygen to the substantially airtight interior; and
a plurality of inflatable ribs provided along a length of the containment wall, the inflatable ribs defining one or more air compartments separate from the interior region within the containment wall, the inflatable ribs supporting a pressure sufficient to support the containment wall away from the patient.

2. A containment device as claimed in claim 1, wherein the containment wall is formed from polyvinyl chloride.

3. A containment device as claimed in claim 2, wherein the inflatable ribs are formed of nylon and adhered to the containment wall.

4. A containment device as claimed in claim 3, wherein the inflatable ribs are formed of a flexible thermoplastic material.

5. A containment device as claimed in claim 1, further comprising a fluid channel connecting the inflatable ribs to one another for simultaneously filling a fluid to or discharging a fluid from the ribs.

6. A containment device as claimed in claim 1, wherein each of the ribs has a filling aperture to receive a gas injection device.

7. A containment device as claimed in claim 1, wherein the inflatable ribs have a compressed gas cartridge contained therein and a puncture mechanism to puncture the gas cartridge from outside of the inflatable ribs.

8. A containment device as claimed in claim 1, further comprising a foam injector connectable to the inflatable ribs to fill the inflatable ribs with a foam which hardens after injection.

9. A containment device as claimed in claim 1, wherein the inflatable ribs contain a foam precursor containment device, the containment device being activated from outside of the inflatable ribs to release a foam which expands into the ribs and hardens after release.

10. A containment device as claimed in claim 1, wherein the ribs are formed of a continuous tube of material adhered to the containment wall on one side of the tube.

11. A containment device as claimed in claim 1, wherein each of the inflatable ribs has opposing flaps extending from the rib, the opposing flaps being substantially parallel to the containment wall and adhered to the containment wall.

12. A containment device as claimed in claim 1, wherein the inflatable ribs are formed of a different material from the containment wall.

13. A containment device as claimed in claim 1, wherein the inflatable ribs are formed of the same material as the containment wall.

14. A containment device as claimed in claim 1, wherein the ribs are attached to the containment wall by RF welding.

15. A containment device as claimed in claim 1, wherein the containment wall is formed of a plurality of thermoplastic sections adhered to one another.

16. A containment device as claimed in claim 1, wherein the containment wall has a single piece of material extending around the patient, the single piece of material having opposing ends with closure units on each of the ends for sealing the ends together.

17. A containment device as claimed in claim 1, wherein the device is 100% disposable.

18. A collapsible, protective containment device for isolating a patient in a controlled environment, comprising:
a flexible containment wall expandable from a collapsed state to define an interior region for receiving at least a portion of a patient therein and providing an impermeable barrier about the portion of the patient, for at least a selected contaminant, the containment wall having first and second ends;
an air ventilation device to provide a gas comprising oxygen to the substantially airtight interior; and
a closure device to seal the first and second ends of containment wall to one another, the closure device comprising:
first and second opposing lips connectable by two manipulatable zipper seals, the first and second lips extending respectively from the first and second ends of the containment wall, the two zipper seals comprising a first pair of strips provided on the first lip and a second pair of strips provided on the second lip, the first pair of strips each having a reclosably interlocking profile to seal the first pair of strips to the second pair of strip via complimentary reclosably interlocking profiles provided in the second pair of strips; and
a flap permanently attached to the first end of the containment wall, the flap having an adhesive strip and a release layer, to seal the flap to the second end of the containment wall after the release layer have been removed.

19. A containment device as claimed in claim 18, wherein
the strips of the first pair of strips have different profiles, and
the strips of the second pair of strips have different profiles.

20. A collapsible, protective containment device for isolating a patient in a controlled environment, comprising:
a flexible containment wall expandable from a collapsed state to define an interior region for receiving at least a portion of a patient therein and providing an impermeable barrier about the portion of the patient, for at least a selected contaminant, the containment wall having first and second sides;
an air ventilation device to provide a gas comprising oxygen to the substantially airtight interior; and
a closure device to seal the first and second sides of containment wall to one another, the closure device comprising:
a first manipulatable zipper seal formed from first and second strips provided respectively at ends of the first and second sides of the containment wall, the first and second strips having reclosable interlocking profiles;
first and second flaps extending from the first and second sides of the containment wall, respectively, the first and second flaps having a second manipulatable zipper seal formed from third and fourth strips provided respectively on the first and second flaps, the third and fourth strips having reclosable interlocking profiles;
an adhesive flap provided on the containment wall such that the first flap is attached to the first side of the containment wall between respective first end of the containment wall and the adhesive flap, the adhesive flap having an adhesive strip and a release layer to seal the adhesive flap to a sealing position on the second side of the the containment wall after the release layer has been removed, the sealing position being located such that the second flap is attached to the second side of the containment wall between the respective end of the containment wall and the sealing position.

21. A containment device as claimed in claim 20, wherein the first and second manipulatable zipper seals seal in opposite directions.

22. A collapsible, protective containment device for isolating a patient in a controlled environment, comprising:
a flexible containment wall expandable from a collapsed state to define an interior region for receiving at least a portion of a patient therein and providing an impermeable barrier about the portion of the patient, for at least a selected contaminant;
a closure device for closing the containment wall about the patient to provide a substantially airtight interior region;
an air ventilation device to provide a gas comprising oxygen to the substantially airtight interior;
a flexible sleeve sealed to and extending through the containment wall;
an adapter sealed to the flexible sleeve and having an inner circumference that defines an aperture;
a removable container to hold patient fluid, the container fitting within the aperture in the adapter, the container having a sealed end that temporarily opens when pierced;
an injection unit fastened to the flexible sleeve and having first and second ends, the first end having a needle to pierce the patient's skin, the second end being in fluid communication with the first end and having a tip to pierce the sealed end of the container; and
a cap connectable to the adapter to hold the second end of the injection unit within the sealed end of the container.

23. A containment device according to claim 22, wherein the patient fluid is blood withdrawn from the patient.

24. A collapsible, protective containment device for isolating a patient in a controlled environment, comprising:
a flexible containment wall expandable from a collapsed state to define an interior region for receiving at least a portion of a patient therein and providing an impermeable barrier about the portion of the patient, for at least a selected contaminant;
a closure device for the closing containment wall about the patient to provide a substantially airtight interior region;
an air ventilation device to provide a gas comprising oxygen to the substantially airtight interior; and
an aperture in the containment wall;
a first aperture sealing unit to seal the aperture from the at least one contaminant, the first aperture sealing unit providing a first access to the patient;
a second aperture sealing unit to seal the aperture temporarily while the first aperture sealing unit is still attached to the aperture; and
a third aperture sealing unit covering the aperture while the second aperture sealing unit is attached to the aperture, the third aperture sealing unit providing a second access to the patient.

25. A containment device as claimed in claim 24, wherein the first and second aperture sealing units are gloves.

26. A containment device as claimed in claim 24, further comprising a glove access port provided in the containment wall to selectively remove the first and second aperture sealing units into the interior region.

27. A containment device as claimed in claim 24, wherein the second aperture sealing unit is an inflation device that seals to the sleeve.

28. A collapsible, protective containment device for isolating a patient in a controlled environment, comprising:
a flexible containment wall expandable from a collapsed state to define an interior region for receiving at least a portion of a patient therein and providing an impermeable barrier about the portion of the patient, for at least a selected contaminant;
a closure device for closing the containment wall about the patient to provide a substantially airtight interior region;
an air ventilation device to provide a gas comprising oxygen to the substantially airtight interior;
a tubular adapter extending from the containment wall to define an aperture in the containment wall, the tubular adapter having inner and outer surfaces, the inner surface having an inner groove formed therein and the outer surface having an outer groove formed therein;
an accessory to fit within the tubular adapter for patient access, the accessory comprising a sleeve with an elastic bead at one end thereof, the elastic bead fitting within the outer groove; and
an O-ring fitting within the inner groove to hold the sleeve against the inner surface of the tubular adapter.

29. A containment device as claimed in claim 28, wherein the tubular adapter has a circular cross-section.

30. A collapsible, protective containment device for isolating a patient in a controlled environment, comprising:
a flexible containment wall expandable from a collapsed state to define an interior region for receiving at least a portion of a patient therein and providing an impermeable barrier about the portion of the patient, for at least a selected contaminant;
a closure device for the closing containment wall about the patient to provide a substantially airtight interior region;
an air ventilation device to provide a gas comprising oxygen to the substantially airtight interior; and
a call unit provided within the interior region, the call unit having an alert unit and an activation mechanism manipulatable by the patient to trigger the alert unit and request patient attention from outside of the interior region.

31. A containment device as claimed in claim 30, wherein
the activation mechanism is a switch,
the alert unit is provided outside of the interior region, and
the activation mechanism is connected to alert unit via a communication link extending through the containment wall.

32. A containment device as claimed in claim 31, wherein the communication link is a pneumatic link.

33. A containment device as claimed in claim 31, wherein the communication link is a wireless link.

34. A containment device as claimed in claim 32, wherein the communication link is a wired link.

35. A containment device as claimed in claim 30, wherein the activation mechanism is a e interior region.
